(19) United States
(12) Patent Application Publication
(10) Pub. No.: US 2011/0274814 A1
(43) Pub. Date: Nov. 10, 2011

(54) Garlic Based Pepper Vegetarian Sauce

(76) Inventor: Amit Shah, (US)

(21) Appl. No.: 12/775,684

(22) Filed: May 7, 2010

(51) Int. Cl. A23L 1/221

(52) U.S. Cl. 426/589

(57) ABSTRACT

A garlic-based sauce which includes garlic, chili peppers, bell peppers, a quantity of flavorings and spices. These ingredients are combined without addition of any preservatives. The method of preparing the garlic-based sauce includes caramelized chili peppers by heating or broiling and blending the ingredients into a mixture, mixing spices and flavorings.

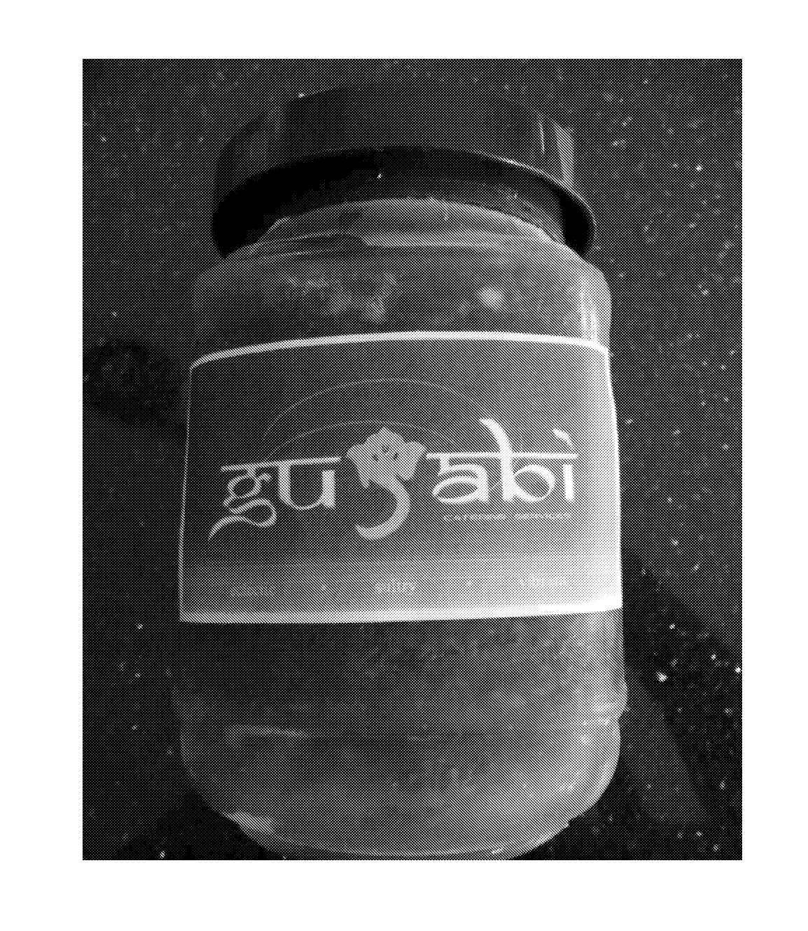

### BACKGROUND OF THE INVENTION

This Invention relates to preparing a pepper based garlic sauce.

Garlic-based sauces are popular items in the diets of many people and many families. Conventionally, the modern consumer utilizes ready-made products of one of the major food-product companies when preparing the evening meal or while serving appetizers made of other products.

What the ready-made products offer in terms of convenience they typically lack in flavor. It is known that the processing necessary for providing an adequate shelf-life for such sauces, such as treatment at high temperatures, serve to degrade their flavor, texture, and color, for example.

Attempts to improve the appeal of such ready-made products have led to the development of lines of sauces within brands. Such lines include names as such “roasted garlic,” “roasted peppers and garlic,” and “sun-dried garlic,”.

Home-made sauces can require somewhat more time for a typical consumer to make and they can be somewhat more flavorful than the ready-made type, particularly when fresh ingredients are used. Nevertheless, there remains a need for a sauce that is flavorful and is different from sauces that are presently known.

It is known that known sauces include a variety of different additives, such as different spices, to affect the flavor of the resultant sauce. Known sauces have flavors in which certain constituents dominate, i.e., sauces have flavors dominated by the taste of salt, garlic, or oregano. In general, however, known sauces have a generally predictable texture and taste.

### SUMMARY OF THE INVENTION

The present invention relates generally to a garlic-based sauce and a process for making such sauce using fresh ingredients. More particularly, the invention is related to a sauce which includes caramelized or broiling chili peppers being an additive to the sauce including uncarmelized peppers which are additional components of the sauce. The sauce being vegetarian in content.

### DETAILED DESCRIPTION

The invention is a garlic based pepper vegetarian sauce and method of preparation.

It is an object of the invention to provide a garlic-based sauce, particularly such a sauce intended for flavoring foods, which has a unique texture and taste and is completely vegetarian.

More particularly, the garlic-based sauce of the invention includes a substantial amount of peppers, which adds a hot and sweet taste and which enables a caramelization during the preparation of the sauce. Whereas the amount of peppers is known to be added in sauces, it is known to be used for the purpose of balancing the acid content of the garlic.

In a preferred embodiment of the sauce of the invention, no quantity of meat is included and is completely vegetarian.

In that embodiment, which produces about 64 ounces of sauce and can serve about 30 people, cloves of garlic, long green chills, green and red bell peppers, salt or sea salt, and vinegar are used. The sauces can be produced in varieties of salt levels and types including a No Salt or Low-Salt version.

It is contemplated that, additional quantities of 8, 12, 16, 24, 32 or 48 ounces of sauce can be created by reducing or adding the above components in relative quantities.

The components garlic, caramelized or broiled long green chili peppers, green and red bell peppers are pureed. The sauce thus prepared has a sweet and hot, garlic taste. The substantial amount of peppers adds a unique character to the sauce. The sauce has a unique flavor and texture by virtue of the peppers, salt and vinegar.

In summary of the foregoing, the invention contemplates the preparation of a garlic-based sauce which includes a mixture of components. The mixture of components includes a quantity of fresh garlic and a quantity of peppers in the proportion of 1 ounce of garlic to about 16 ounces of green bell peppers, 24 ounces of red bell peppers and 16 ounces of caramelized or broiled long green chili peppers with an addition of 4 teaspoons of salt and 1 cup of vinegar. The ingredients are pureed to a fine mixture and chilled before bottling. The sauce in question to be packaged under the name “Gujabi's Hot Garlic Sauce” or “Gujabi's Spicy Garlic Sauce”. The packaging format will be a labeled glass bottle with a screw cap and tamper proof seal. The bottles may vary in size based on weight of the sauce being bottled and as described above.

What is claimed is:

1. A garlic-based sauce, comprising the following ingredients
a) garlic;
b) long green chili peppers;
c) bell peppers;
d) spices namely, salt, no-salt and red chilli pepper;
e) water; and
f) vinegar,
wherein said ingredients are combined without any preservatives.

2. The sauce of claim 1, wherein said vinegar comprises white vinegar.

3. The sauce of claim 1, where said water comprises regular or purified water.

4. The sauce of claim 1, where said salt comprises regular salt, no-salt or sea salt.

5. The sauce of claim 1, where said garlic comprises fresh garlic.

6. The sauce of claim 1, where said chili peppers comprise long green chili peppers or jalapenos.

7. The sauce of claim 1, where said bell peppers are green and red.

8. The sauce of claim 1, further comprising: a quantity of flavorings or spices.

9. The sauce of claim 1, where said proportion comprises 1 ounce of garlic to about 16 ounces of green bell peppers, 24 ounces of red bell peppers and 16 ounces of caramelized or broiled long green chili peppers.

10. The sauce of claim 1, wherein said quantity of flavorings or spices comprises at least one of the following flavorings: salt and vinegar.

11. The sauce of claim 1, where for each said portion of peppers to garlic further comprises a quantity of flavoring or spices in proportion as follows: said quantity of salt not to exceed 4 teaspoons and said vinegar not to exceed 1 cup in measurement.

12. The sauce of claim 1, where for each said portion of peppers to garlic further comprises a quantity of flavorings or spices, said quantity of flavorings or spices does not comprise any animal based meats or products.

13. A method of preparing the sauce of claim 1, comprising the steps of:
a) proportion of long green chili peppers are caramelized or broiled for 5 to 10 minutes to enhance the flavoring.
b) all ingredients comprising of garlic, broiled or caramelized long green chili peppers, bell peppers which have been finely chopped, spices, water and vinegar are pureed in a liquefier.
